(19) United States
(12) Patent Application Publication
(10) Pub. No.: US 2011/0118874 A1
(43) Pub. Date: May 19, 2011

(54) ROBOT CONTROLLER SIMULTANEOUSLY CONTROLLING N NUMBER OF ROBOTS

(75) Inventors: Yoshikiyo TANABE, Minamitsuru-gun (JP); Nobuo CHINO, Minamitsuru-gun (JP); Yoshiki HASHIMOTO, Minamitsuru-gun (JP)

(73) Assignee: FANUC LTD, Minamitsuru-gun (JP)

(21) Appl. No.: 12/868,794

(22) Filed: Aug. 26, 2010

(30) Foreign Application Priority Data
Nov. 18, 2009 (JP) 2009-263299

(51) Int. Cl. G05B 19/418

(52) U.S. Cl. 700/248

(57) ABSTRACT

A robot controller which simultaneously controls N (N≧2) number of robots (R1 to Rn), provided with a main control unit (MCU), the main control unit including a main processor (MP) which prepares operational commands each of the N number of robots and a servo processor (SP) which uses the operational commands prepared by the main processor as the basis to calculate amounts of operation of servo motors which drive each of the robots, and furthermore provided with N number of amplifier units (AU1 to AUn) connected to the main control unit, each including a servo amplifier (SA1 to SAn) which uses amounts of operations of servo motors calculated by the servo processor to drive servo motors of one robot among the N number of robots. Due to this, it is easy to add and remove robots and the cost can be lowered and the size reduced.

### BACKGROUND OF THE INVENTION

1. Field of the Invention

The present invention relates to a robot controller controlling N number of robots, in particular N number of industrial robots.

2. Description of the Related Art

In the past, industrial robots have been controlled by robot controllers connected to them by cables etc. FIG. 5 is a block diagram of the functions of a control system in the related art as disclosed in Japanese Patent Publication (A) No. 2001-150372. The robot controller RC1 shown in FIG. 5 includes a main processor MP1 which prepares operational commands of the robot R1, a servo processor SP1 which calculates amounts of operation of servo motors based on the operational commands, and a servo amplifier SA1 which drives servo motors (not shown) in the robot R1 based on the calculated amounts of operation.

Further, the main processor MP1 of the robot controller RC1 is connected to a teaching pendant 110a, while the servo amplifier SA1 is connected to the robot R1. The other robot controllers RC2 to RCn are similarly configured. In other words, in FIG. 5, the plurality of robots R1 to Rn are respectively controlled by separate robot controllers RC1 to RCn.

Along with the improvement in processing abilities of the main processors MP1 to MPn and servo processors SP1 to SPn, in recent years, a single robot controller RC0 has come to be used to control a plurality of robots R1 to Rn.

FIG. 6 is a block diagram of the functions of such a control system in the related art as disclosed in Japanese Patent Publication (A) No. 2005-262369. In FIG. 6, a robot controller RC0 connected to a teaching pendant 110 includes a single main processor MP and servo processor SP plus a plurality of servo amplifiers SA1 to SAn. In FIG. 6, the single main processor MP and servo processor SP prepare amounts of operation for the plurality of robots R1 to Rn and control the plurality of robots R1 to Rn through the servo amplifiers SA1 to SAn respectively.

For this reason, in the configuration shown in FIG. 6, cooperative control enabling a plurality of robots R1 to Rn to work in concert becomes possible. Further, the communication between the robots R1 to Rn and peripheral equipment (emergency stop switches, light curtains, sensors, etc.) and interlock control of the robots R1 to Rn are performed by a single robot controller RC0, so communication and programming between the robots R1 to Rn and peripheral equipment become easier. Furthermore, in the configuration shown in FIG. 6, compared with the case of FIG. 5, the numbers of the teaching pendants and the robot controllers with their operation panels, main processors MP, and servo processors SP are reduced, so the system as a whole can be reduced in cost.

Furthermore, FIG. 7 is a block diagram of the functions of another control system in the related art as disclosed in Japanese Patent Publication (A) No. 2006-187826. In the configuration shown in FIG. 7, the robot controller RC0′ to which the teaching pendant 110′ is connected includes first and second central processing units CPUa and CPUb.

Further, between the robot controller RC0′ and the robots R1 to Rn, reverse processors RP1 to RPn are arranged. As shown in the figure, the reverse processors RP1 to RPn are respectively provided with third central processing units CPUc1 to CPUcn and servo amplifiers SA1 to SAn.

In this regard, the configuration shown in FIG. 6 enables the system as a whole to be reduced in cost, but it is necessary to mount a plurality of servo amplifiers SA1 to SAn in the housing of the robot controller RC0. Therefore, when controlling a large number of robots, it is necessary to prepare a large sized housing able to hold a large number of servo amplifiers.

Furthermore, in the configuration shown in FIG. 7, each time adding a new robot, it is necessary to add a reverse processor RPn. This was disadvantageous to the reduction of cost and the reduction of size of the robot controller itself.

The present invention was made in consideration of this situation and has as its object the provision of a low cost, small sized robot controller enabling easy addition and removal of robots.

### SUMMARY OF THE INVENTION

To achieve the above object, according to a first aspect of the invention, there is provided a robot controller which simultaneously controls N (N≧2) number of robots, wherein the robot controller is provided with a main control unit, the main control unit including a main processor which prepares operational commands of each of the N number of robots and a servo processor which uses the operational commands prepared by the main processor as the basis to calculate amounts of operation of servo motors driving each of the robots, and is provided with N number of amplifier units connected to the main control unit, each amplifier unit including a servo amplifier which uses the amounts of operation of servo motors calculated by the servo processor as the basis to drive servo motors of one robot among the N number of robots.

According to a second aspect of the invention, there is provided a robot controller which simultaneously controls N (N≧2) number of robots, wherein the robot controller is provided with a main control unit, the main control unit including a main processor which prepares operational commands of each of the N number of robots, a servo processor which uses the operational commands prepared by the main processor as the basis to calculate amounts of operation of servo motors driving each of the robots, and a servo amplifier which drives servo motors of one robot among the N number of robots, and is provided with N−1 number of amplifier units connected to the main control unit, each amplifier unit including a servo amplifier which uses the amounts of operation of servo motors calculated by the servo processor as the basis to drive servo motors of one robot among the N−1 number of robots other than the one robot from the N number of robots.

According to a third aspect of the invention, there is provided the first or second aspect of the invention wherein the amplifier units are connected in a daisy chain to the main control unit, and the main control unit and the amplifier units are used in a state stacked over each other.

According to a fourth aspect of the invention, there is provided the first or second aspect of the invention wherein the amplifier units are made the same outer shapes as each other.

According to a fifth aspect of the invention, there is provided the first or second aspect of the invention wherein each of the amplifier units includes an emergency stop circuit which makes the respective servo amplifier stop when receiving a command from a higher controller.

### BRIEF DESCRIPTION OF THE DRAWINGS

These and other objects, features and advantages of the present invention will be more apparent in light of the detailed description of exemplary embodiments thereof as illustrated by the drawings, wherein

FIG. 1 is a block diagram of the functions of a robot controller according to a first embodiment of the present invention,

FIG. 2 is a partial perspective view of the robot controller shown in FIG. 1,

FIG. 3 is a block diagram of the functions of a robot controller according to a second embodiment of the present invention,

FIG. 4 is a perspective view of a main control unit and amplifier units in the robot controller shown in FIG. 1,

FIG. 5 is a block diagram of the functions of a control system in the related art,

FIG. 6 is a block diagram of the functions of another control system in the related art, and

FIG. 7 is a block diagram of the functions of still another control system in the related art.

### DETAILED DESCRIPTION

Below, embodiments of the present invention will be explained with reference to the attached drawings. In the following figures, similar members are assigned similar reference numerals. To facilitate understanding, these figures are suitably changed in scale.

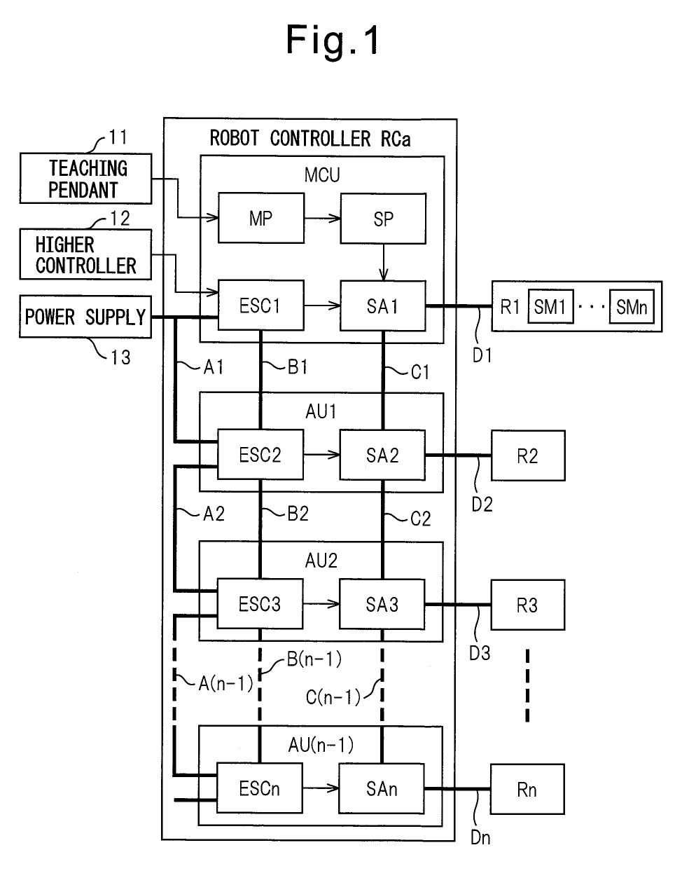

FIG. 1 is a block diagram of the functions of a robot controller according to a first embodiment of the present invention. The robot controller RCa shown in FIG. 1 mainly includes a single main control unit MCU and at least one amplifier unit AU1 to AU(n−1). Here, the letter “n” in the Specification means an integer of 2 or more. Further, the robot controller RCa has a teaching pendant 11, a higher controller 12, and a power supply 13 connected to it.

The teaching pendant 11 is provided with a screen and a plurality of input keys (all not shown). Processing for the screen display and input keys of the teaching pendant 11 is performed through the main processor MP. The operator uses the teaching pendant 11 to select the robot to be taught and thereby enables a teaching operation for the selected robot.

Further, a robot program is run by a startup signal from the teaching pendant 11 or the outside. Note that, the robot program may be run for only the robot selected by the teaching pendant 11 or may be run for all of the plurality of robots R1 to Rn.

Furthermore, the higher controller 12 is for example a PLC and can send emergency stop signals, for making the robots R1 to Rn stop in emergencies, to the robot controller RCa in accordance with need. The power supply 13 supplies the power required by the robot controller RCa, in particular the current required by the servo amplifiers SA (explained later) of the amplifier units AU.

The robots R1 to Rn controlled by the robot controller RCa of the present invention are, for example, vertical articulated robots or other industrial robots. As shown in FIG. 1, the robot R1 includes a number of servo motors SM1 to SMn corresponding to the number of articulations. The other robots R2 to Rn are similarly configured, but for simplification, the servo motors SM1 to SMn of the robots other than the robot R1 are not shown.

As shown in FIG. 1, the main control unit MCU includes a main processor MP which prepares operational commands of the robots R1 to Rn and a servo processor SP which calculates the amounts of operation (current commands) of the related servo motors based on the prepared operational commands. Furthermore, the main control unit MCU includes a servo amplifier SA1 connected by a robot connector cable D1 to the robot R1. The servo amplifier SA1 converts the current commands received from the servo processor SP by PWM (pulse width modulation) and controls the currents of the servo motors SM1 to SMn of the robot R1.

Furthermore, the main control unit MCU includes an emergency stop circuit ESC1 connected to the higher controller 12. The emergency stop circuit ESC1 shuts off the power of the robot R1 when an emergency stop signal is sent from the higher controller 12.

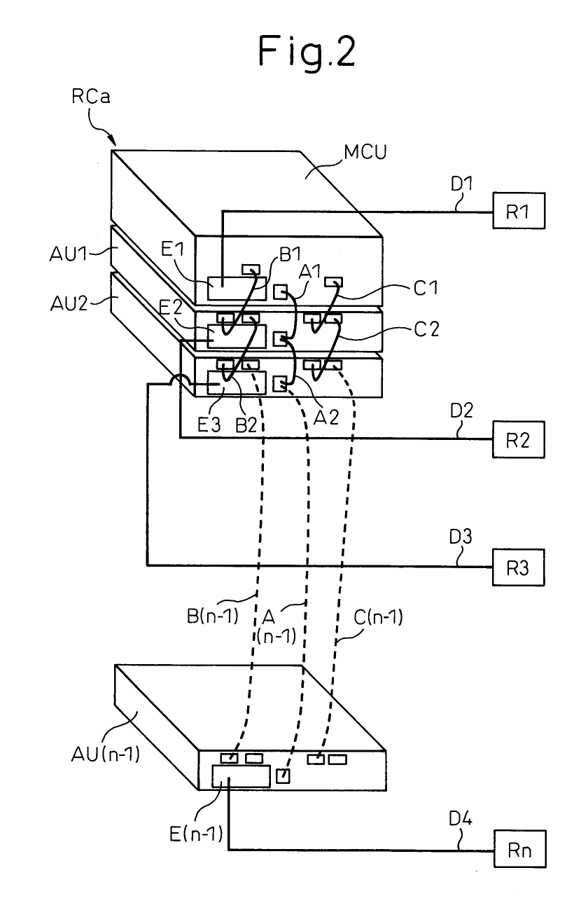

The amplifier units AU1 to AU(n−1) respectively include emergency stop circuits ESC2 to ESC(n−1) and servo amplifiers SA2 to SA(n−1) configured in the same way as above. FIG. 2 is a partial perspective view of the robot controller shown in FIG. 1. As can be seen from FIG. 1 and FIG. 2, a power cable A1 supplying current through the emergency stop circuit ESC1 to the servo amplifier is connected in a daisy chain between the main control unit MCU and the amplifier unit AU1. Similarly, the remaining amplifier units AU2 to AU(n−1) are also connected by power cables A2 to A(n−1) in a daisy chain.

Further, the emergency stop signals prepared for the robots R1 to Rn are supplied from the higher controller 12 by an emergency stop signal cable B1 connected in a daisy chain between the main control unit MCU and the amplifier unit AU1. Similarly, the remaining amplifier units AU2 to AU(n−1) are also connected by emergency stop signal cables B2 to B(n−1) in a daisy chain.

Furthermore, the amounts of operation of the servo motors SM1 to SMn are supplied to the servo amplifier SA2 of the amplifier unit AU1 by the control command cable C1 connected in a daisy chain between the main control unit MCU and the amplifier unit AU1. Similarly, the remaining amplifier units AU2 to AU(n−1) are also connected by control command cables C2 to C(n−1) in a daisy chain. Furthermore, the robots R2 to Rn are connected by robot connector cables D2 to Dn to the amplifier units AU1 to AU(n−1).

In this way, in the present invention, the power cables A1 to A(n−1), emergency stop signal cables B1 to B(n−1), and control command cables C1 to C(n−1) are connected by a daisy chain between the main control unit MCU and the amplifier units AU1 to AU(n−1).

For this reason, when adding a new robot R(n+1), it is sufficient to prepare a new amplifier unit AUn and use a power cable etc. to connect it to the amplifier unit AU(n−1) in the daisy chain. Therefore, in the present invention, it is possible to easy add a robot while controlling a plurality of robots.

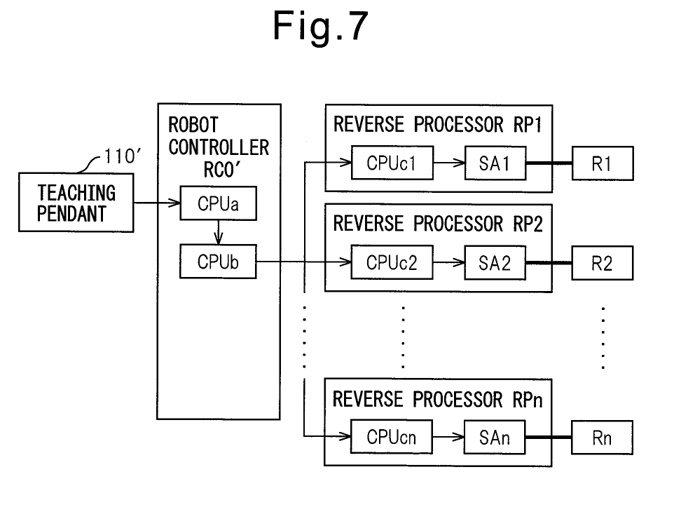

Further, the amplifier units AU1 to AUn of the present invention do not include third central processing units (see FIG. 7) etc., so the amplifier units AU1 to AUn themselves are relatively small in size. As a result, the robot controller RCa as a whole can be reduced in size. Note that, when there is no need to make the robots R1 to Rn individually stop, the emergency stop circuits ESC1 to ESCn and emergency stop signal cables may also be eliminated. In that case, the amplifier units AU1 to AUn can be further reduced in size.

Furthermore, when removing a robot Rn, it is sufficient to disconnect the daisy chain-connected power cable A(n−1), emergency stop signal cable B(n−1), and control command cable C(n−1) and detach the amplifier unit AU(n−1). In this way, in the present invention, by detaching the amplifier unit AU(n−1), a robot Rn can be easily removed.

Further, the main control unit MCU and the amplifier units AU1 to AU(n−1) respectively include emergency stop circuits ESC2 to ESC(n−1), so can make the corresponding robots R1 to Rn individually stop. This is advantageous for when disconnecting specific robots R1 to Rn not expected to be used in certain work or when there is a need to cut power to the robots R1 to Rn not requiring teaching.

Note that, as shown in FIG. 2, the main control unit MCU is provided with an interface E1 for connection of the robot R1. Similarly, the amplifier units AU1 to AU(n−1) are provided with interfaces E2 to E(n−1) for connection of the robots R2 to Rn respectively. These interfaces E1 to E(n−1) are made ones shaped the same as each other. Further, the interfaces of the power cables A, emergency stop signal cables B, and control command cables C are also shaped the same as each other.

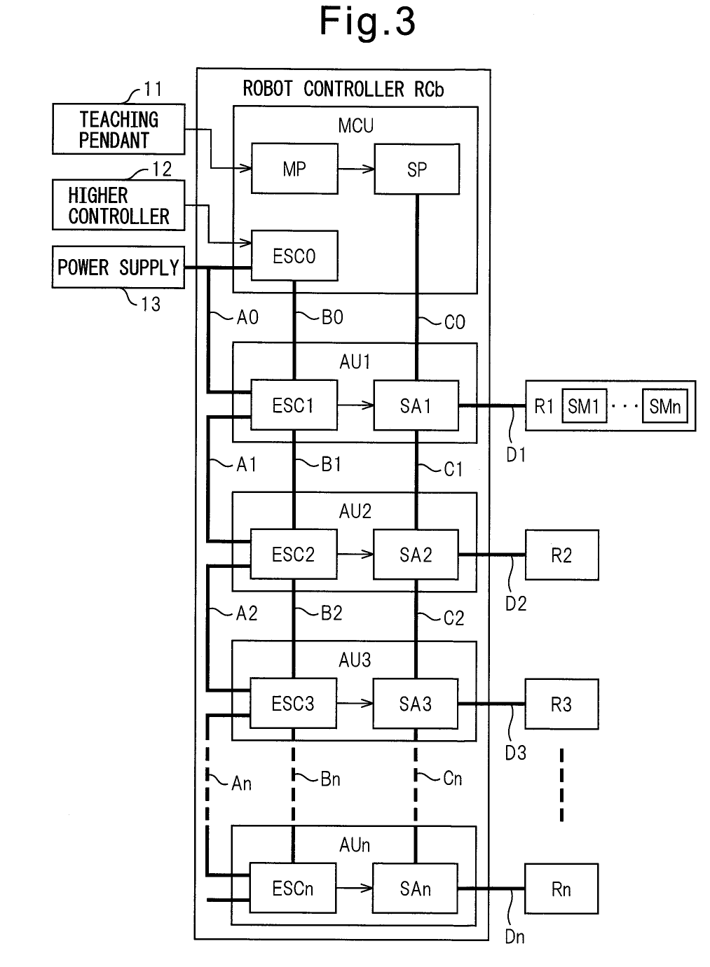

FIG. 3 is a block diagram of the functions of a robot controller based on a second embodiment of the present invention. The robot controller RCb shown in FIG. 3 mainly includes a single main control unit MCU and at least two amplifier units AU1 to AUn.

In the second embodiment, the main control unit MCU includes a main processor MP and a servo processor SP. However, the main control unit MCU shown in FIG. 3 is not provided with a servo amplifier SA connected to the robot R1. Instead, the main control unit MCU includes an emergency stop circuit ESC0 connected to the amplifier unit AU1.

Further, except for the differences in the reference numerals of the emergency stop circuit ESC and servo amplifier SA, the amplifier units AU1 to AUn in the second embodiment are generally configured the same as the above-mentioned amplifier unit, so explanations will be omitted. Further, as can be seen from FIG. 3, the power cable A0, emergency stop signal cable B0, and control command cable C0 connect the main control unit MCU and the amplifier unit AU1.

Since configured in this way, in the second embodiment, the main control unit MCU does not directly control the robot R1. All of the robots R1 to Rn are controlled by the corresponding amplifier units AU1 to

AUn. In such a case, the robot R1 and the main control unit MCU are not directly linked, so the robot R1 can be extremely easily separated from the main control unit MCU. Therefore, this is particularly advantageous when replacing the robot R1 with a new type of robot. Note that, in the second embodiment as well, it will be clear that similar effects to those explained in the first embodiment can be obtained.

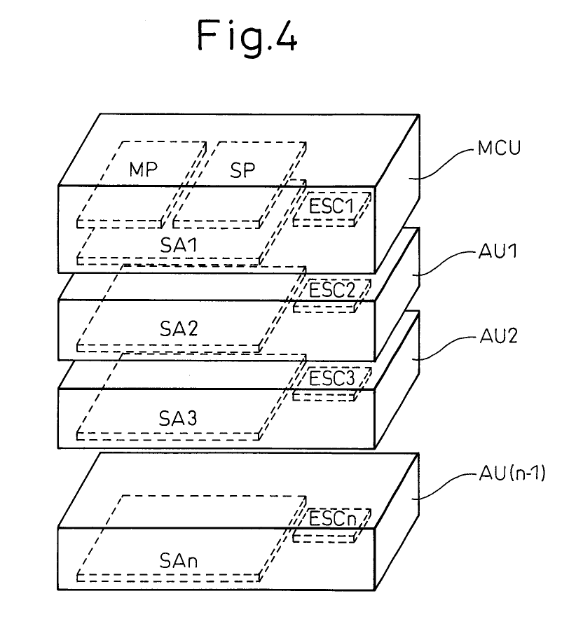

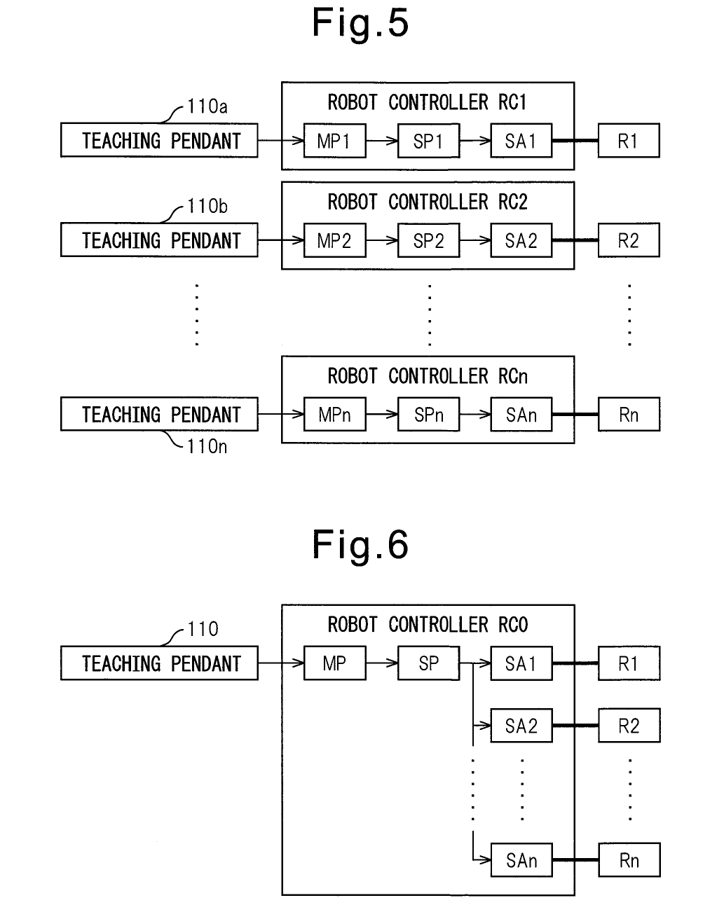

Further, FIG. 4 is a perspective view of the main control unit and amplifier units in the robot controller shown in FIG. 1. As shown in FIG. 2 and FIG. 4, the main control unit MCU and the amplifier units AU1, AU2 . . . are used stacked over each other. Further, as can be seen from FIG. 4, the main control unit MCU and the amplifier unit AU1, AU2 . . . are equal in footprints with each other. Therefore, in the present invention, if the footprint of the main control unit MCU can be secured, the places for placement of the plurality of amplifier units AU1 to AUn can also be secured. Therefore, the robot controller itself can be reduced in size.

Further, the amplifier units AU do not include the main processor MP and servo processor SP, so the amplifier units AU can be formed smaller (thinner) than the main control unit MCU. Further, the amplifier units AU1 to AUn are equal to each other in outer shape. From these, in the present invention, it will be understood that the robot controller can also be reduced in cost.

Note that, in FIG. 2, the main control unit MCU is stacked over the amplifier units AU1 to AU(n−1), but the amplifier units AU1 to AU(n−1) may also be stacked over the main control unit MCU. It is clear that this case as well is included in the scope of the present invention.

In the first and second aspects of the invention, by just adding amplifier units, it becomes possible to easily add robots and control a plurality of robots. Further, it is also possible to detach amplifier units so as to easily remove robots. The amplifier units do not include members other than servo amplifiers, for example, third central processing units, so can be reduced in size compared with the reverse processing units. Therefore, the robot controller as a whole can also be reduced in size.

In the third or fourth aspect of the invention, the robot controller itself can be reduced in size and lowered in cost by a relatively simple configuration.

In the fifth aspect of the invention, the robots corresponding to the amplifier units can be individually stopped.

Although the invention has been shown and described with exemplary embodiments thereof, it should be understood by those skilled in the art that the foregoing and various other changes, omissions and additions may be made therein and thereto without departing from the scope of the invention.

1. A robot controller which simultaneously controls N (N≧2) number of robots, wherein the robot controller is provided with
a main control unit,
the main control unit including a main processor which prepares operational commands of each of the N number of robots and a servo processor which uses the operational commands prepared by the main processor as the basis to calculate amounts of operation of servo motors driving each of the robots, and is provided with
N number of amplifier units connected to the main control unit,
each of the amplifier units including a servo amplifier which uses the amounts of operation of servo motors calculated by the servo processor as the basis to drive servo motors of one robot among the N number of robots.

2. A robot controller which simultaneously controls N (N≧2) number of robots, wherein the robot controller is provided with
a main control unit,
the main control unit including a main processor which prepares operational commands of each of the N number of robots, a servo processor which uses the operational commands prepared by the main processor as the basis to calculate amounts of operation of servo motors driving each of the robots, and a servo amplifier which drives servo motors of one robot among the N number of robots, and is provided with
N−1 number of amplifier units connected to the main control unit,
each of the amplifier units including a servo amplifier which uses the amounts of operation of servo motors calculated by the servo processor as the basis to drive servo motors of one robot among the N−1 number of robots other than the one robot from the N number of robots.

3. A robot controller as set forth in claim 1, wherein the amplifier units are connected in a daisy chain to the main control unit, and the main control unit and the amplifier units are used in a state stacked over each other.

4. A robot controller as set forth in claim 1, wherein the amplifier units are made the same outer shapes as each other.

5. A robot controller as set forth in claim 1, wherein each of the amplifier units includes an emergency stop circuit which makes the respective servo amplifier stop when receiving a command from a higher controller.

6. A robot controller as set forth in claim 2, wherein the amplifier units are connected in a daisy chain to the main control unit, and the main control unit and the amplifier units are used in a state stacked over each other.

7. A robot controller as set forth in claim 2, wherein the amplifier units are made the same outer shapes as each other.

8. A robot controller as set forth in claim 2, wherein each of the amplifier units includes an emergency stop circuit which makes the respective servo amplifier stop when receiving a command from a higher controller.
